(19) United States
(12) Patent Application Publication
(10) Pub. No.: US 2026/0166509 A1
(43) Pub. Date: Jun. 18, 2026

(54) PROCESS FOR THE OXIDATIVE PRE-MELTING AND SMELTING OF A METALLIFEROUS FEEDSTOCK MATERIAL-CONTAINING AGGLOMERATE

(71) Applicant: AFRICAN RAINBOW MINERALS LIMITED, Johannesburg (ZA)

(72) Inventors: Marius VISSER, Cape Town (ZA); Johannes Hendrik ZIETSMAN, Pretoria (ZA); Nicole Jane SWEETEN, Pretoria (ZA); Petrus Hendrik Ferreira BOUWER, Johannesburg (ZA)

(73) Assignee: AFRICAN RAINBOW MINERALS LIMITED, Johannesburg (ZA)

(21) Appl. No.: 19/128,875

(22) PCT Filed: Dec. 13, 2022
(86) PCT No.: PCT/IB2022/062116

§ 371 Date: May 9, 2025

(51) Int. Cl. B01J 8/24; B01D 53/73; B01J 8/18; C22B 4/00

(52) U.S. Cl. CPC B01J 8/24; B01D 53/73; B01J 8/1872; C22B 4/00

(57) ABSTRACT

The invention relates to a process for the smelting of a manganese-containing feedstock material utilising oxidative pre-melting, the process comprising the steps of: feeding agglomerates comprising a manganese-containing feedstock material to a reactor 12 and forming a packed bed 14 of the agglomerates in the reactor 12; feeding a hot oxidizing gas into the reactor 12 and passing the hot oxidizing gas through the packed bed 14 of agglomerates to form an oxidized fluid material comprising a liquid phase; channeling the fluid material to flow from the reactor 12 into an electrothermal furnace 26; adding a reductant to the fluid material in the electrothermal furnace 26 to form a manganese metal product, a slag product and a CO-containing gas; and combusting the CO-containing gas to form the hot oxidizing gas and feeding the hot oxidising gas back to the reactor.

### CROSS REFERENCE TO RELATED APPLICATION

This application is a 35 U.S.C. § 371 National Stage of International Patent Application No. PCT/IB2022/062116, filed Dec. 13, 2022, the disclosures of which are incorporated herein in their entirety by reference, and priority is claimed to the foregoing.

### FIELD OF THE INVENTION

The invention relates to a process for the smelting of a manganese-containing feedstock material. More particularly, the invention relates to a process for the smelting of a manganese-containing feedstock material utilizing oxidative pre-melting of the manganese-containing feedstock material with a combustion product of an electrothermal furnace CO-containing off-gas.

### BACKGROUND TO THE INVENTION

Technology or process route selection for the smelting of metalliferous feedstock materials, including manganese-containing feedstock materials, requires taking into account a number of considerations, with operating consideration such as metallurgical efficiency and energy efficiency largely considered as being of primary concern.

Process routes entailing the pre-reduction of an agglomerated metalliferous feed material prior to carbothermic smelting in an electric furnace are predominantly known in the art. The focus on such process routes is due to the proven metallurgical and electrical energy efficiencies during carbothermic smelting of an agglomerated feed material (allowing closer quality control, i.e., mechanical and chemical property control) which has been pre-heated and subjected to pre-reduction in advance of the carbothermic smelting.

In this context and most prominently are such processes wherein the pre-reduction treatment comprises direct or solid-state reduction. In the alternative, WO 2020/229994 discloses a process for the smelting of a reductant-containing metalliferous feed material wherein the pre-reduction comprises not only heating and solid-state reduction, but melting of the feed material through use of a hot reducing gas from a gasifier, the products of which are then allowed to flow into an electric furnace for final slag cleaning.

In further increasing metallurgical and electrical energy efficiencies, it is known to utilise, as feed material to the above-described solid-state reduction, the product agglomerate from a solid-state oxidation process, such as sintering in air.

However, a fundamental disadvantage remains where solid-state oxidation is utilised in advance of pre-reduction, in that material transfer between the pre-treatment steps and/or a pre-treatment step and the carbothermic smelting step remains viable only in the solid state and as a result, cooling down of the material in transit occurs. This cooling down reduces the specific energy consumption (SEC) of the overall process as any subsequent step would then require re-heating of the feed material, at least to the extent of the heat loss during transfer.

Furthermore, it is known that solid-state pre-oxidation negatively impacts on the mechanical properties of the agglomerate, such as through the calcining of carbonates present in the feed material, and therefore a disadvantage arises in the fact that the extent of pre-oxidation is limited in order to avoid the formation of deleterious fines during solid-state material transfer.

Accordingly, the known process routes come with disadvantages in SEC, either due to avoidance of the disadvantages associated with solid-state pre-oxidation or through a limitation of solid-state pre-oxidation, coupled with increased reductant consumption due to the requirement to utilise pre-reduction in order to achieve feasible metallurgical and energy efficiencies during electric furnace smelting.

Further to the above-described disadvantages in the known process steps upstream of carbothermic smelting, it is commonplace that a final off-gas from the electric furnace is flared into the environment to avoid discharging a CO-rich gas. This flaring, by its very nature, introduces a chemical energy inefficiency in the process as a result of the loss of a high chemical energy product to the non-productive flaring.

Furnace off-gas has seen limited application as a recycle in metallurgical processes, and to date has seen no application beyond for purposes of pre-heating and/or solid-state pre-reduction of a metalliferous feed material, with current literature providing that even electrothermal furnace off-gas does not have the requisite chemical energy content to achieve any more than the aforementioned pre-heating and/or solid-state pre-reduction.

### OBJECT OF THE INVENTION

It is accordingly an object of the present invention to provide a novel process for the smelting of a manganese-containing feedstock material which overcomes, at least partially, the abovementioned disadvantages and limitation and/or which will provide useful alternative to existing processes for the smelting of a manganese-containing feedstock materials.

### SUMMARY OF THE INVENTION

According to the invention, there is provided a process for the smelting of a manganese-containing feedstock material, the process comprising the steps of:
forming a packed bed of agglomerates comprising the manganese-containing feedstock material in a reactor;
feeding a hot oxidizing gas into the reactor and passing the hot oxidizing gas through the packed bed of agglomerates to form an oxidized fluid material comprising a liquid phase;
channeling the fluid material to flow from the reactor into an electrothermal furnace;
adding a reductant to the fluid material in the electrothermal furnace to form a manganese metal product, a slag product and a CO-containing gas; and
combusting the CO-containing gas to form the hot oxidizing gas and feeding the hot oxidising gas back to the reactor.

Smelting in the present context is to be understood as the process of extracting manganese from a manganese-containing feedstock material. The manganese-containing feedstock material may be any material, such as an ore, scrap, concentrate, slag or the like, or any combination of such materials, which material combination of materials comprise a metal or metal-containing compound of manganese (Mn).

The manganese-containing feedstock material may be a fine feedstock material. In the current context, reference to fine in relation to particle size is a particle size of less than or equal to 6 mm, preferably less than 100 μm at 80% passing sieve size (P80).

The agglomerates comprising the manganese-containing feedstock material may further comprise a flux. The agglomerates may still further comprise a binding agent. It is to be appreciated that where the manganese-containing feedstock material is self-fluxing, the agglomerates need not comprise a flux. Therefore, the agglomerates may comprise only the manganese-containing feedstock material.

Addition of flux to the agglomerates may be selected and controlled to allow forming a liquid phase having a viscosity less than 20 P, preferably less than 5 P, most preferably equal to or less than 2 P to allow for channeling the fluid material from the reactor into the electrothermal furnace.

The flux may comprise a carbonate mineral. The carbonate mineral may be dolomite and/or limestone. The flux may comprise a silicate mineral. The silicate mineral may be quartz. The flux may comprise a carbonate mineral and a silicate mineral.

The binding agent may be bentonite. The binding agent may be cement. The binding agent may be a combination of bentonite and cement.

The liquid phase may comprise an intermediate slag constituent. The fluid material may further comprise an oxidized metalliferous constituent.

It is to be understood that an electrothermal furnace is a furnace with a heat source derived from electricity. The electrothermal furnace may be an electric arc furnace, the electric arc furnace may be an electric arc furnace of the type used in open bath smelting.

The heat source allows for the at least partial metallization of manganese in the fluid material in the presence of the reductant to form the manganese metal product and at least a portion of the slag product. The oxidized metalliferous constituent and/or the intermediate slag constituent may comprise manganese.

The manganese metal product and at least a portion of the slag product may be formed via an electrochemical reaction between the reductant and manganese-containing constituents in the fluid material, the intermediate slag constituent serving as an electrolyte.

The operating temperature in the electrothermal furnace may be controlled to selectively metallize manganese, thereby allowing metallization of manganese to form the metal product and allowing non-target metals to at least partially report to the slag product.

The degree of metallization of manganese in the manganese-containing feedstock material in the process may be up to 99%.

The CO-containing gas may be combusted in air to form the hot oxidizing gas. Combustion of the CO-containing gas to form the hot oxidizing gas may occur in a combustion chamber, wherefrom it is fed back to the reactor.

A hot oxidizing gas in the present context is to be understood as a gas wherein the mass % of CO₂+O₂ in the gas is greater than the mass % of CO+H₂ in the gas and which gas, when fed into the reactor, has a temperature high enough to heat and at least partially melt the agglomerate, based on the composition of the agglomerate, to form the fluid material such that it can be channeled from the reactor into the electrothermal furnace.

Accordingly, the fluid material may be formed through the heating and melting or at least partial melting of the agglomerates in the packed bed.

The (CO₂+O₂)/(CO+H₂) of the hot oxidizing gas may be greater than 5, preferably greater than 10.

The mass % of CO₂ in the hot oxidizing gas may be greater than or equal to 20%, preferably greater than 25%. The mass % of O₂ in the hot oxidizing gas may be greater than or equal to 2%, preferably greater than 3.5%.

The hot oxidizing gas may be fed into the reactor at a temperature above 1200° C., preferably above 1350° C., the temperature being dependent on the manganese-containing feedstock material being processed.

It should be appreciated that the fluid material comprises oxidized manganese and/or an oxidized manganese-containing compound of the manganese-containing feedstock material, which manganese and/or manganese-containing compound has been so oxidized by means of the hot oxidizing gas.

The residence time of the agglomerate in the packed bed may be controlled to impact the degree of oxidation of the manganese-containing feedstock material in the reactor.

The electrothermal furnace may be separate from and in fluid flow communication with the reactor.

The reductant may be anthracite. The anthracite may be added to the electrothermal furnace as particulates having a particle size equal to or less than 30 mm, preferably having a P80 of equal to or less than 15 mm.

The reductant may be added to the electrothermal furnace by means of ultrasonic injection.

The step of forming the packed bed of the agglomerates in the reactor may be preceded by a step of feeding the agglomerates into the reactor.

The hot oxidizing gas may be passed counter current to the agglomerates through the packed bed.

The packed bed may include a fluid permeable interface at an operatively downstream position relative to a region where the agglomerates are fed into the reactor, the fluid permeable interface permitting the fluid material to pass therethrough. The fluid permeable interface may be an operatively base region of the packed bed suspended in the reactor.

The packed bed may be suspended by side walls of the reactor at a position at which the direction of the side walls of the reactor changes or at a position at which there is a narrowing of the side walls of the reactor. The packed bed may be suspended by an obstruction located in the reactor, the obstruction being at an operatively downstream position relative to the region where agglomerates are fed to the reactor. The obstruction may be a fluid permeable bed of refractories.

The slag product may be transferred for further hydrometallurgical and/or pyrometallurgical processing.

The step of feeding the agglomerates into the reactor may be preceded by a step of producing the agglomerates. The agglomerates may be produced at a production facility.

It is to be appreciated that the steps of the process according to the invention need not necessarily be executed sequentially, as the process may be operated in a batch, semi-batch or continuous manner. Furthermore, it is envisaged that the steps of the process provided for need not necessarily be executed in the order listed herein.

### BRIEF DESCRIPTION OF THE DRAWINGS

The invention will now further be described, by way of example only, with reference to the accompanying diagrams wherein:

FIG. 1 is a schematic process flow diagram of a process for the smelting of a manganese-containing feedstock material according to the invention; and

FIG. 2 is a cross-sectional side view of a reactor and an electrothermal furnace as employed in the process of FIG. 1.

### DETAILED DESCRIPTION OF THE INVENTION

The invention described herein is not to be limited in scope by any specific embodiment or example herein disclosed, as the embodiments and examples are intended as illustrative of several aspects of the invention. Any equivalent embodiments are intended to be within the scope of this invention, as they will become apparent to those skilled in the art from the present description.

A process for the smelting of a manganese-containing feedstock material according to the invention is generally designated by reference numeral 10 in the accompanying diagrams.

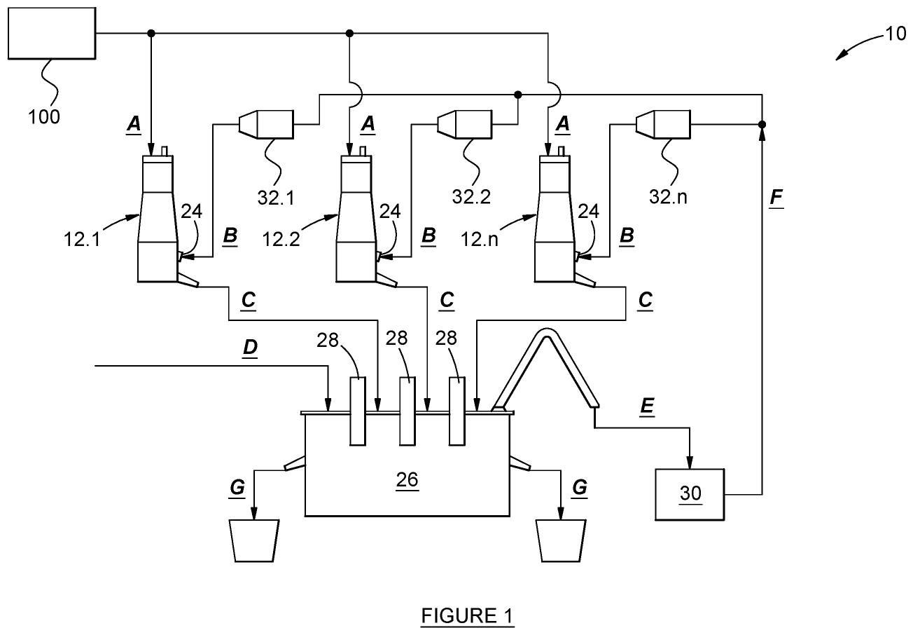

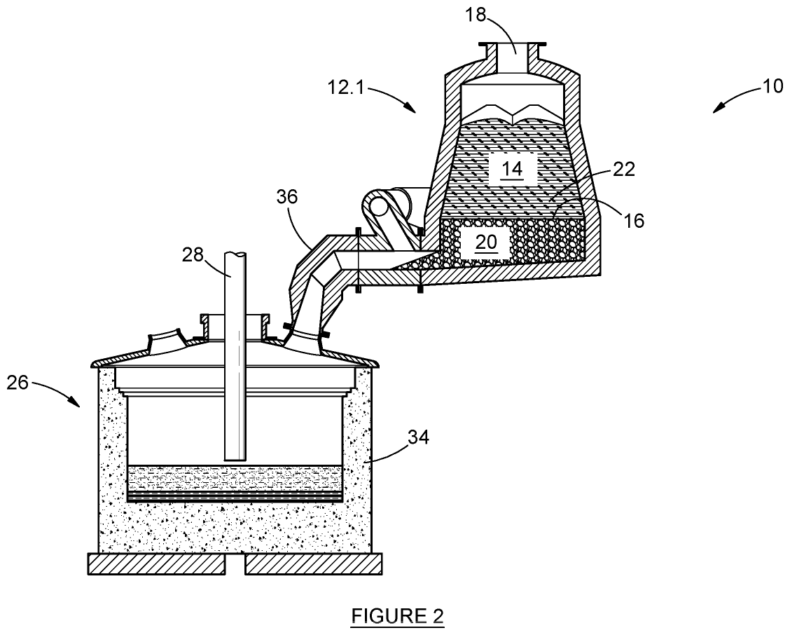

FIG. 1 shows a schematic representation of the process 10 flow. Agglomerates comprising fine manganese-containing feedstock material (not shown) and a flux, prepared at a preparation facility 100 (with no reductant added during its production), are fed A into reactors 12.1 (shown in greater detail in FIG. 2) through 12.n where it forms part of a fluid permeable packed bed of agglomerates 14 (shown in FIG. 2 with reference to reactor 12.1) in each respective reactor 12.1 through 12.n.

With reference to reactor 12.1, the packed bed 14 comprises a fluid permeable interface 16 (shown in FIG. 2) at an operatively downstream position relative to a region 18 where the agglomerates are fed A into the reactor 12.1 (shown in FIG. 2). In the embodiment shown in FIG. 2, the packed bed 14, and there with the fluid permeable interface 16 at an operatively base region of the packed bed 14, is allowed to form in the reactor 12.1 as a result of the operatively base region of the packed bed 14 being suspended by an obstruction 20 comprising a fluid permeable bed of refractories. This packed bed 14 is stacked between 2 and 3 meters high in the reactor 12.1.

It is to be appreciated that, during preparation of the agglomerates at the preparation facility 100, the manganese-containing feedstock material, as a fine material preferably having a particle size distribution with a P80 of less than 100 μm, is dispersed within the agglomerates. Ideally, an agglomerate has a diameter of between 10 mm and 20 mm, but the process 10 is able to accommodate agglomerates with a diameter of anything between 2 mm and 80 mm and even more. Accordingly, an advantage of the process 10, as a result of this packed bed 14 configuration in the reactor 12.1, among further features exemplified further below, is that agglomerates with limited strength and therefore limited, or no binder content can be utilised, while simultaneously avoiding the constraints introduced by diminishing mechanical properties of the agglomerates as a result of oxidation during the process 10, surprisingly rather allowing the resultant porosity in the agglomerates from oxidation to advance the operation of the packed bed 14 by increasing fluid permeability and agglomerate surface area.

It will be appreciated that it may be well be elected to include a binder or binding agent, and the use or disuse of binder or binding agent would depend on the manganese-containing feedstock material being processed, the size of the agglomerate used in the process 10 and/or the height at which the packed bed 14 of agglomerates is required to be stacked in the reactor 12.

By means of being suspended by the obstruction 20, the agglomerates in the packed bed 14 are then heated and partially melted by means of passing a hot oxidizing gas counter current through the packed bed 14. The hot oxidizing gas is fed B at a velocity of between 3 and 4 m/s at an operatively downstream position 24 of the packed bed 14 at a temperature sufficient to partially melt the agglomerates and counter current to the direction in which agglomerates are fed to the reactor 12.1, thereby permeating the packed bed 14.

In this fashion, the pressure-drop of the hot oxidizing gas across the permeable fluid interface 16 and packed bed 14 is minimized and typically in the order of 5 to 10 kPa.

The temperature of the hot oxidizing gas, after having passed through the permeable bed 14 of agglomerates, is typically less than 300° C.

The heating and partial melting of the agglomerates in the reactor 12.1 result in the formation of a fluid material comprising a liquid phase, this liquid phase comprising an intermediate slag constituent. The fluid material, by means of partial oxidation of the agglomerates through use of the hot oxidizing gas, also contains an oxidized metalliferous constituent, with the oxidized metalliferous constituent entrained in the intermediate slag constituent. Accordingly, the fluid permeable interface 16, formed at an operatively lower region 22 of the packed bed 14 allows:
(i) the hot oxidizing gas to pass therethrough and into the packed bed 14; and
(ii) the fluid material to flow out of and away from the packed bed 14.

By controlling the viscosity of the liquid intermediate slag constituent, whether by the addition of a fluxing agent in the agglomerate and/or self-fluxing of the manganese-containing feedstock material, the fluid material can be channeled C and flows into an electrothermal furnace 26 (shown as a closed submerged arc AC furnace in FIG. 1) where a reductant is added D to the fluid material contained in the furnace 26. As shown in FIG. 2, the furnace 26 is provided in fluid flow communication with the reactor 12.1, thereby minimising heat loss during transfer of the fluid material. The reductant, as particulate anthracite, in combination with electrical energy added to the molten material by means of submerged electrodes 28 of the furnace 26 advances and allows for the formation of a manganese metal product, a slag product and a CO-containing gas. The manganese metal product and slag product, when contained in the furnace 26, would necessarily be in liquid form, but it will be appreciated by those skilled in the art that solid particles may however also still be present.

The manganese metal product and the slag product, in an embodiment of the invention, are formed in the furnace 26 via open bath smelting as a result of an electrochemical reaction between the reductant and manganese or manganese-containing compounds, such as a spinel, in the fluid material. The reduction of manganese or manganese-containing compounds in this manner, as part of an oxidized fluid material feed to the furnace 26, allows the metallisation to proceed to much higher levels compared to conventional smelting as known in the art.

The liquid manganese metal product and the liquid slag product can then be tapped G from the furnace 26 as known in the art. The liquid manganese metal product and/or the liquid slag product may then be processed further as required. Reference to a liquid manganese metal product in this regard should be appreciated as including reference to any manganese containing alloy, such as ferromanganese.

Importantly, the CO-containing gas is captured E from the furnace 26 and passed to a quencher 30 where after the quenched gas is fed F to combustion chambers 32.1 through 32.n wherein it is combusted in air to form the hot oxidizing gas which is recycled into the process 10 and used to heat, at least partially melt and at least partially oxidize the agglomerates in any one or all of the reactors 12.1 through 12.n.

### Process Control

A fundamental advantage of the process 10 is that it allows for:
i) the exploitation of high SEC efficiencies through the at least partial melting and oxidation of the agglomerate prior to carbothermic smelting in the furnace 26;
ii) the mitigation of energy losses by allowing transfer of a fluid material from the reactor 12 to the furnace 26; and
iii) recycling of the CO-containing gas into the process 10 through combustion of the CO-containing gas to produce the hot oxidizing gas suitable for heating and at least partial melting of the agglomerates in the reactor 12,
   while allowing a very high degree of process control to achieve high metallurgical and energy (both electrical and chemical) efficiencies.

By example, melting of the agglomerate and viscosity of the resultant fluid material is controlled by a number of physical and chemical characteristics of the constituents of the agglomerate, when subjected to the hot oxidizing gas. The melting temperature of gangue materials and the viscosity of the resultant liquid phase, and thereby of the fluid material, may be decreased by adding a suitable flux to the agglomerate. The nature or type of manganese-containing feedstock material would also influence melting of the agglomerate; by example and all else being equal, where the hot oxidizing gas reacts with a manganese oxide ore-containing agglomerate to break the spinel, forming a ferrous oxide and a manganese(ii)oxide, the ferrous oxide may melt in the reactor 12 while the manganese(ii)oxide forms part of a sold oxidized metalliferous constituent.

Therefore, where the process 10 includes a preparation facility 100, the process 10 allows for controlling the composition of the agglomerates such that melting the agglomerates is controlled as well as the viscosity of the resultant fluid material. Such a change in the melting and resultant fluid material viscosity can in turn impact on the rate of melting of constituents of the agglomerate, the degree of oxidation of the manganese-containing feedstock material in the reactor 12.1 and the ease at which the fluid material flows to the furnace 26.

To illustrate, and if desired, by lowering the melting temperature of gangue materials in the agglomerate and decreasing the fluid material viscosity through the addition of a flux, such as limestone or dolomite, the rate of melting of gangue materials in the agglomerate may be increased at a given hot oxidizing gas temperature and therefore the fluid material will permeate through the packed bed 14 at a higher rate. This in turn will result in a decreased residence time of agglomerates in the packed bed 14, which in turn decreases the degree of oxidation of the manganese-containing feedstock material in the reactor 12.1.

Importantly, the process 10 further allows for controlling:
i) the addition D of the reductant to the furnace 26 itself; and
ii) the extent of the combustion of the CO-containing gas in the combustion chambers 32.1 through 32.n,
   such that the hot oxidizing gas has a CO₂+O₂ content greater than its CO+H₂ content sufficient to produce the oxidized metalliferous constituent from an agglomerate (by example, a mass % CO₂ greater than 25% and a mass % of O₂ greater than 2%) and at a temperature sufficient to heat and at least partially melt the agglomerate.

Simultaneously, the process 10 allows for control of the addition of:
i) reductant to the fluid material in the furnace 26 itself;
ii) electrical energy to the fluid material in the furnace 26; and
iii) flux in the agglomerate,
to:
i) ensure a target CO-content of the CO-containing gas;
ii) establish an operating temperature in the furnace 26 to form the manganese metal product and the slag product suitable for tapping G from the furnace 26; and
iii) manipulate the basicity of the fluid material and slag product such that it is compatible with a refractory lining 34 of the furnace 26 and/or a refractory lining of a duct 36 for channeling the fluid material from the reactor 12 to the furnace 26.

Accordingly, the process 10, contrary to the established understanding in the art that agglomerates comprising refractory manganese-containing feedstock material, such as oxide ores of manganese, cannot be sufficiently melted through the use of chemical energy alone, much less through utilising the chemical energy of a furnace product gas, allows these agglomerates to be simultaneously oxidized and sufficiently melted to allow for fluid material transfer between a pre-oxidation treatment and carbothermic smelting, whilst increasing metallurgical and energy efficiencies during carbothermic smelting in the furnace 26.

The description is presented by way of example only in the cause of providing what believed to be the most useful and readily understood description of the principles and conceptual aspects of the invention. In this regard, no attempt is made to show structural details of the invention and/or the equipment utilised therein in more detail than is necessary for a fundamental understanding of the invention.

1.-27. (canceled)

28. A process for the smelting of a manganese-containing feedstock material, the process comprising the steps of:
i) forming a packed bed of agglomerates comprising the manganese-containing feedstock material in a reactor, wherein the agglomerates are self-fluxing or further comprise a flux;
ii) feeding a hot oxidizing gas, at a temperature of above 1200° C., into the reactor and passing the hot oxidizing gas through the packed bed of agglomerates to form an oxidized fluid material comprising a liquid phase, wherein the viscosity of the oxidized fluid material is controlled to be no more than 2 P by varying the amount of flux added to the agglomerate, wherein the flux is a carbonate mineral and/or a silicate mineral; and wherein the degree of oxidation of the oxidized fluid material is dependent on the amount of flux added to the agglomerates;
iii) channeling the oxidized fluid material to flow from the reactor into an electrothermal furnace;
iv) adding a reductant to the fluid material in the electrothermal furnace to form a manganese metal product, a slag product and a CO-containing gas, wherein controlling the addition of the reductant to the fluid material in the furnace and controlling the addition of electrical energy to the fluid material in the furnace ensures that at least a target CO-content of the CO-containing gas is achieved; and
v) combusting the CO-containing gas to form the hot oxidizing gas and feeding the hot oxidizing gas back to the reactor.

29. The process of claim 28, wherein the step of forming the packed bed of agglomerates in the reactor is preceded by a step of feeding the agglomerates into the reactor.

30. The process of claim 29, wherein the step of feeding the agglomerates into the reactor is preceded by a step of producing the agglomerates.

31. The process of claim 28, wherein the hot oxidizing gas has a (CO₂+O₂)/(CO+H₂) ratio greater than 5.

32. The process of claim 31, wherein the hot oxidizing gas has a (CO₂+O₂)/(CO+H₂) ratio greater than 10.

33. The process of claim 28, wherein the manganese-containing feedstock material is any material, such as an ore, scrap, concentrate, slag or the like, or any combination of such materials, which material or combination of materials comprise a metal or metal-containing compound of manganese (Mn).

34. The process of claim 28, wherein the manganese-containing feedstock material is a fine manganese-containing feedstock material.

35. The process of claim 34, wherein the fine manganese-containing feedstock material has a particle size of less than or equal to 6 mm at 80% passing sieve size (P80).

36. The process of claim 35, wherein the fine manganese-containing feedstock material has a particle size of less than 100 μm at 80% passing sieve size (P80).

37. The process of claim 29, wherein the hot oxidizing gas is passed through the packed bed counter current to the feed of the agglomerates.

38. The process of claim 28, wherein the electrothermal furnace is separate from and in fluid flow communication with the reactor.

39. The process of claim 38, wherein the electrothermal furnace is an electric arc furnace.

40. The process of claim 28, wherein the reductant is anthracite having a particle size equal to or less than 30 mm.

41. The process of claim 40, wherein the anthracite has a particle size distribution having a P80 of equal to or less than 15mm.

42. The process of claim 41, wherein the anthracite is added to the oxidized fluid material in the electrothermal furnace by means of ultrasonic injection.

43. The process of claim 29, wherein the packed bed of agglomerates includes a fluid permeable interface at an operatively downstream position relative to a region where the agglomerates are fed to the reactor, the fluid permeable interface permitting the fluid material to pass therethrough.

44. The process of claim 43, wherein the packed bed of agglomerates is suspended by side walls of the reactor.

45. The process of claim 44, wherein the packed bed of agglomerates is suspended by an obstruction located in the reactor.

46. The process of claim wherein the fluid permeable interface is at an operatively base region of the packed bed of agglomerates suspended in the reactor.

47. The process of claim 28, wherein the fluid material comprises an intermediate slag constituent and the forming of the manganese metal product in the electrothermal furnace at least partially comprises an electrochemical reaction between the reductant and an oxidized manganese and/or an oxidized manganese-containing compound in the fluid material with the intermediate slag constituent serving as an electrolyte.

48. The process of claim 28, wherein the agglomerate includes a binder.

49. The process of claim 28, wherein forming the manganese metal product, the slag product and the CO-containing gas in the electrothermal furnace comprises controlling the operating temperature of the electrothermal furnace to selectively metallize manganese.

50. The process of claim 28, wherein the step of combusting the CO-containing gas to form the hot oxidizing gas comprises combusting the CO-containing gas in air in a combustion chamber.

51. The process of claim 47, wherein the mass % of CO2 in the hot oxidizing gas is greater than or equal to 20% and the mass % of O2 in the hot oxidizing is greater than or equal to 2%.
